(19) United States
(12) Patent Application Publication
(10) Pub. No.: US 2003/0192419 A1
(43) Pub. Date: Oct. 16, 2003

(54) Double-sided saw blade

(76) Inventor: Tomasso Conti, Hyannis, MA (US)

Correspondence Address: Julia Sullivan, Esq., P.O. Box 3229, Oak Bluffs, MA, 02557, US

(21) Appl. No.: 10/045,382

(22) Filed: Apr. 10, 2002

(51) Int. Cl. B27B 33/00

(52) U.S. Cl. 83/837

(57) ABSTRACT

A two-sided saw blade, which may have differently sized or shaped teeth, is used in a reciprocal saw or, in an alternate embodiment, in a jigsaw. The saw may be used to cut different material without removing and reinserting a new blade. The saw can also be used from a variety of positions without removing the blade, reversing it, and reinserting it into the saw.

### FIELD OF THE INVENTION

The present invention relates to saw blades used in reciprocal saws, jigsaws, and other such saws.

### BACKGROUND OF THE INVENTION

Construction workers use electrical saws with removable blades for a variety of uses. A saw such as a reciprocal saw or a jig saw may be used with a variety of blades, depending upon the material being cut. A worker who is cutting a structure such as a roof may encounter several different materials. For example, while cutting a roof, the worker may encounter wood, asphalt shingles and nails. The worker using a saw made to cut wood has to stop cutting, and change to a blade to cut metal in order to cut through the nail without ruining the blade for cutting wood.

In addition, construction workers frequently must cut materials from awkward positions, and to facilitate cutting, reverse the blade in the saw so that the saw can be used from a different angle. The worker must therefore stop working, remove the blade, reverse the blade, and then reattach the blade to the saw.

It is therefore an object of the present invention to provide a double-sided saw blade, which may have different cutting patterns on either side of the blade, in order to allow cutting of different materials without changing the saw blade.

It is a further object of the invention to provide a double-sided saw blade in order to allow cutting of materials using either side of the saw blade while using the saw from different angles.

It is also an object of the invention to provide a saw blade that reduces strain on a power tool by easily providing the correct blade.

It is an additional object of the invention to provide a saw blade that has a longer life.

These and other objects and features are provided by the invention, as is described in the following specification and claims.

### SUMMARY OF THE INVENTION

The present invention is a two-sided saw blade for use in reciprocal saws, jigsaws, and other such saws. One side of the blade may have a different cutting pattern from the other side, to allow cutting of different materials without changing the saw blade. In an alternate embodiment, the two sides have identical patterns, which allows use of the saw from different angles.

According to the invention, an elongated substantially flat saw blade is comprised of a first blade end for enabling selective attachment of the saw blade with a reciprocal saw, an opposite second blade end, a first longitudinal cutting edge, and a second longitudinal cutting edge opposed to the first cutting edge. Each cutting edge is comprised of a plurality of slicing teeth. The slicing teeth on the first cutting edge are arranged for cutting a first material, and the slicing teeth on the second cutting edge are arranged for cutting a second material.

### BRIEF DESCRIPTION OF THE DRAWINGS

FIG. 1 is a side sectional view of a prior-art saw blade.

FIG. 2 is a side sectional view of a double-sided saw-blade device in accordance with an embodiment of this invention.

While only the preferred form of the invention is illustrated in the drawings, it will be apparent that certain modifications could be made without departing what is claimed.

### DETAILED DESCRIPTION OF THE INVENTION

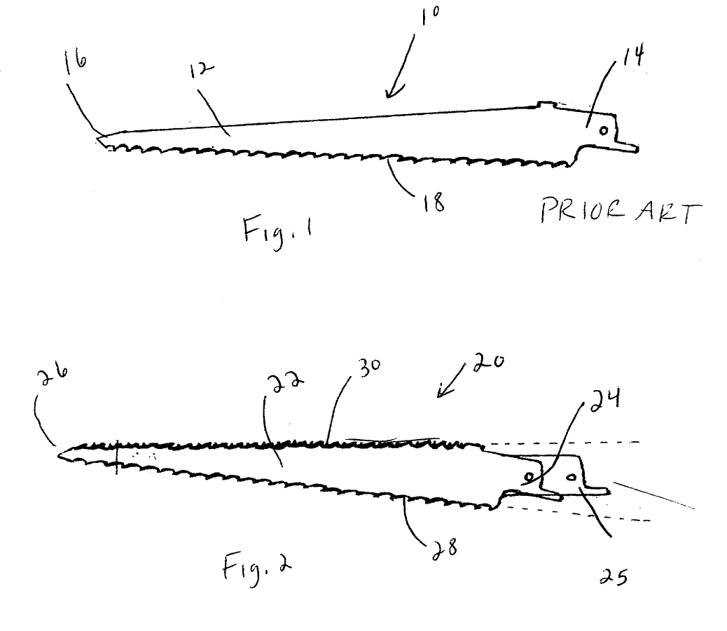

Referring now to FIG. 1, a prior art saw blade 10 is shown. The prior art saw blade 10 comprises an elongated, substantially flat body 12 having a ½″ universal tang end 14 and a distal tip end 16, and a cutting edge 18. FIG. 2 shows one embodiment of the double-sided saw blade 20 according to the present invention. The blade is for use in a motor-driven reciprocating blade hand saw such as a “Sawzall” manufactured by the Milwaukee Electric Tool Corporation. These types of hand-held reciprocating saws have a reciprocating spindle driven by the motor to which the saw blade is removably attached.

The double-sided saw blade 20 according to the present invention comprises an elongated, substantially flat body 22 having a ½″ universal tang end 24 and a distal tip end 26, a first longitudinal cutting edge 28 and a spaced apart second longitudinal cutting edge 30. As shown in FIG. 2, the first cutting edge 28 has cutting teeth configured to cut wood, and the second cutting edge 30 has cutting teeth configured to cut metal. The different cutting edges allow a worker to cut two different materials without removing the blade and reinserting a new blade. In the illustrated embodiment, the cutting teeth on the first cutting edge are arranged for cutting a first material, and the slicing teeth on the second cutting edge are arranged for cutting a second material, however, in an alternate embodiment, both cutting edges may have the same configuration of teeth, for example, if a construction worker is cutting only one type of material, but desires to cut it from two directions. It is well known in the prior art to arrange the cutting teeth of a cutting edge of a saw blade according to the material being cut. The teeth may be of different heights, widths, and the teeth may be spaced apart by various distances. According to the present invention, different types of material may be cut using only one blade.

In alternate embodiments, the double-sided blade can also be used in other types of electric hand saws, such as a jigsaw and other such tools.

In one embodiment of the invention, the angle of the tang end 24 is modified from that used in prior art saw blades. As shown in FIG. 2, the tang end 25 of the saw blade extends ¾″ from the saw blade and at an angle parallel to the second cutting edge 30. In an alternate embodiment, the tang end 24 is similar to that of the prior art blade shown in FIG. 1.

Accordingly, I claim:

1. A saw blade, comprising a first blade end for enabling selective attachment of the saw blade with a saw, an opposite second blade end, a first longitudinal cutting edge, and a second longitudinal cutting edge opposed to the first cutting edge.

2. The saw blade of claim 1 wherein each cutting edge is comprised of a plurality of cutting teeth, and wherein the cutting teeth on the first cutting edge are arranged for cutting a first material, and the cutting teeth on the second cutting edge are arranged for cutting a second material.

3. The reciprocating saw blade of claim 2, wherein the first end is a tang end and the second end is a tip end.

4. A reciprocating saw blade, comprising:
an elongated substantially flat member having a first end and a distal second end, a longitudinal first cutting edge and a longitudinal second cutting edge spaced apart from the first cutting edge.

5. The reciprocating saw blade of claim 4 wherein each cutting edge is comprised of a plurality of cutting teeth, and wherein the cutting teeth on the first cutting edge are arranged for cutting a first material, and the cutting teeth on the second cutting edge are arranged for cutting a second material.

6. The reciprocating saw blade of claim 5, wherein the first end is a tang end and the second end is a tip end.

7. A reciprocating saw blade, comprising:
an elongated member having substantially planar right and left sides, a tang end and a distal tip end, a first cutting edge and a spaced apart second cutting edge; wherein each cutting edge is comprised of a plurality of cutting teeth, and wherein the cutting teeth on the first cutting edge are a first height and a first width, and the cutting teeth on the second cutting edge are a second height and a second width.
